(19) United States
(12) Patent Application Publication
(10) Pub. No.: US 2015/0320626 A1
(43) Pub. Date: Nov. 12, 2015

(54) C-SPINE PRESSURE DISTRIBUTIVE SUPPORT

(71) Applicant: Lisa Lander, San Diego, CA (US)

(72) Inventor: Lisa Lander, San Diego, CA (US)

(21) Appl. No.: 14/682,051

(22) Filed: Apr. 8, 2015

Related U.S. Application Data
(60) Provisional application No. 61/977,693, filed on Apr. 10, 2014.

(51) Int. Cl. A61G 7/07; A47G 9/10

(52) U.S. Cl. CPC A61G 7/072; A47G 9/1081; A47G 2009/1018

(57) ABSTRACT

The invention provides a support device for supporting the anatomy of a patient or consumer. The support device has a bottom layer which is in contact with a surface, and a top layer which is in contact with the anatomy of the patient or consumer. The support device is formable into different configurations, depending on the anatomy being supported.

### CROSS-REFERENCE TO RELATED APPLICATIONS

This application claims benefit of priority of U.S. provisional patent application Ser. No. 61/977,693, filed Apr. 10, 2014, entitled “C-SPINE PRESSURE DISTRIBUTIVE SUPPORT”, owned by the owner of the present application and herein Incorporated by reference in its entirety.

### BACKGROUND

In hospitals or patient care settings there is a significant need for adequate C-spine support due to improper alignment and pressure exerted on and to the C-spine. In particular, many patients who are partially supine or otherwise partially-reclined for long periods of time suffer significant neck problems due to pressure exerted on portions of their C-spine. Proper alignment is especially important for people who are sedated, people who are bed bound and are immobile, people in hospice and people who suffer from neck and spine problems, and such often lack the strength to support themselves.

Most patients in the ICU are sedated, supine, and the head of the bed is raised at least 30 degrees. These patients rely on nursing staff to position them periodically, e.g., at least every two hours, or as needed, to alter the pressure of their previous position. Nurses may choose to try and partially alleviate such pressure on the neck with rolled up towels and pillows to try and accommodate this need but it is up to the RN or medical staff. Even with best efforts rolled-up towels and pillows are generally ineffective in supporting proper aligned anatomy. Also, not every nurse will put forth the extra effort required for such accommodation as such is time consuming and facilities often lack sufficient nursing staff. This way of supporting a patient's neck also deleteriously creates extra linen.

Non-hospital environments, e.g., for people who travel and are often on airplanes, trains, chairs, or who fall asleep in sitting positions, as well as people in day spas, and people with cervical spine fusions and injuries, and the like, could also benefit from the proper alignment of their C-spine.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

Certain embodiments of the systems and methods disclosed herein address the deficiencies noted above, and provide convenient and effective relief to pressure at C-spine locations. As an advantageous consequence, the systems and methods allow for optimum blood flow and nerve conduction to the brain. Other advantages include that the systems and methods in certain implementations relieve neck pain and jaw pain due to lack of support.

The systems and methods disclosed allow for the proper alignment and positioning even of patients who are sedated, comatose, or weak, and the same may further be applied within the operating room. Systems and methods disclosed provide support for the C-spine and jaw while the patient is turning from side-to-side in the hospital bed, as well as in nursing homes and hospices.

In addition, the systems and methods aid in head and neck support while the patient is being pulled up in the bed. Often nurses lack the strength to support the head with one hand and pull up the patient with another during repositioning, and this can exacerbate the problem where the torso and trunk move up but the head remains in place and the neck of the patient becomes arched. Patients also generally lack the physical strength to lift their heads to assist the “boost” in the bed. Thus, the systems and methods according to present principles advantageously may allow the head and neck of the patient to keep in alignment and slide against the surface and not create friction.

Also, after major surgeries, doctors commonly desire that patients get out of bed and ambulate but also sit in a chair as long as possible. The patients usually are exhausted and still may have anesthesia wearing off, or be weak from the surgery, and patients can fall asleep in the chair with their necks hanging and unsupported. The systems and methods disclosed help alleviate that problem as well.

A significant benefit to the systems and methods disclosed herein is that the same may be advantageously employed in the prevention of pressure sores, e.g., on the ears and elsewhere, particularly for patients who are laying on their side. Such patients, particularly in the ICU, have poor nutrition, poor blood circulation, and decreased capability of wound healing. Craniectomy patients may be particularly prone to such pressure sores, as such procedures entail removal of a portion of the skull, and such patients cannot be turned on to the side of removal without deleteriously causing pressure directly on brain tissue. Systems and methods according the present principles allow such patients to turn slightly to the affected side, increasing comfort, while not pressing directly on brain tissue.

In one aspect, the invention is directed towards a substantially linear apparatus for supporting anatomy, comprising: an upper layer made of a pressure distributive material; a middle layer made of a soft material; and a lower layer formable by user manipulation.

Implementations of this apparatus may include one or more of the following. The top layer may comprise a pressure distributive gel. The top layer may have a thickness of, e.g., ¼ to 1 inch. The middle layer may be thicker than the top and bottom layers. The middle layer may comprise a viscoelastic foam. The bottom layer may be rigid enough to keep user-formed shapes until the shape is reformed. The apparatus may be shaped to support the anatomy of a head. The apparatus may be shaped to support the anatomy of a neck.

In another aspect, the invention is directed towards a toroidal apparatus for supporting anatomy, comprising: an upper layer made of a pressure distributive material; a middle layer made of a soft material; and a lower layer formable by user manipulation.

Implementations of this apparatus may include one or more of the following. The top layer may comprise a pressure distributive gel. The top layer may have a thickness of ¼ to 1 inch. The middle layer may be thicker than the top and bottom layers. The middle layer may comprise a viscoelastic foam. The bottom layer may be rigid enough to keep user-formed shapes until the shape is reformed.

In yet another aspect, the invention is directed towards a toroidal apparatus for supporting anatomy, comprising: an upper layer made of a pressure distributive material; a middle layer made of a soft material; and a lower layer formable by user manipulation. The toroidal apparatus may be detachably connected by a connecting device to a substantially linear apparatus for supporting anatomy, comprising: an upper layer made of a pressure distributive material; a middle layer made of a soft material; and a lower layer formable by user manipulation. That is, the lower layer may be made of a material that can be manipulated by a user to a particular position, and the same will generally maintain that position until formed into a new position.

Implementations of this apparatus may include one or more of the following. The connecting device may be a hook and loop fastener.

Other advantages and features of the invention will be apparent from the description that follows, including the drawings and claims.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

FIGS. 1(A) and 1(B) illustrate a support device according to an embodiment of the invention.

FIG. 2 illustrates another support device according to an embodiment of the invention.

FIG. 3 illustrates possible configurations of the support device according to various embodiments of the invention.

FIG. 4 illustrates an occipital configuration of the support device according to an embodiment of the invention.

FIG. 5 illustrates an embodiment of the invention where several support devices are connected together

FIG. 6 illustrates an embodiment of the invention where a central section of the support device is wider and/or higher than the ends.

FIG. 7 illustrates an alternative embodiment according to present principles.

FIG. 8 illustrates another alternative embodiment according to present principles.

FIG. 9 illustrates another alternative embodiment according to present principles.

FIGS. 10(A) and 10(B) illustrate another alternative embodiment according to present principles.

FIG. 11 illustrates a side view of the implementation of FIGS. 10(A) and 10(B).

FIG. 12(A)-12(C) illustrate other alternative embodiments according to present principles.

FIG. 13(A)-13(B) illustrate alternative embodiments according to present principles.

FIG. 14 illustrates another alternative embodiment according to present principles.

FIG. 15 schematically illustrates an implementation according to present principles in use with a patient.

FIG. 16 schematically illustrates an implementation according to present principles in use with a patient.

FIG. 17 schematically illustrates an implementation according to present principles in use with a patient.

Like reference numerals refer to like elements throughout. Elements are not to scale unless otherwise noted.

### DETAILED DESCRIPTION

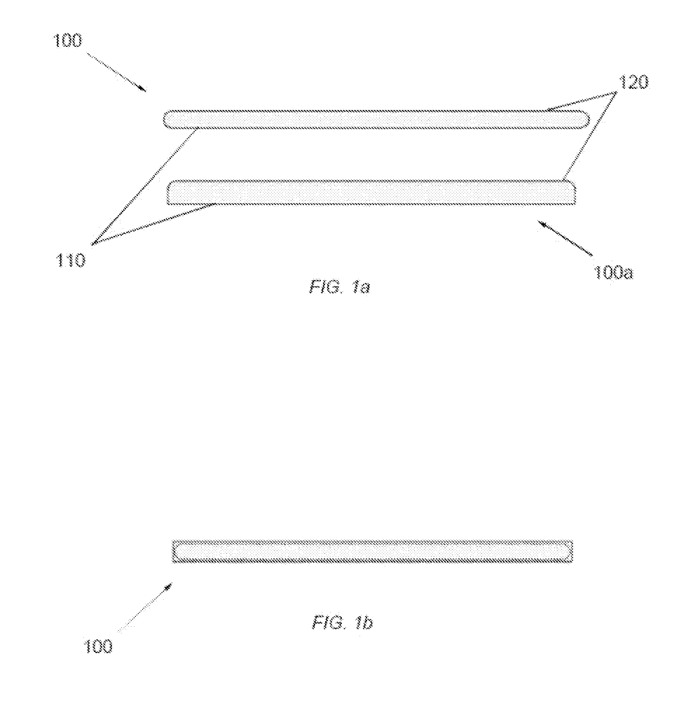

FIG. 1a shows side views and FIG. 1b show a top view of various embodiments of the present invention. As illustrated by FIG. 1a, support device 100 generally includes a flat bottom surface 110 for engagement, e.g., frictional engagement, with a hospital bed or other surface on which the patient or consumer is resting or otherwise contacting. Support device 100 also includes a generally curved upper surface 120 which contacts the patient or consumer. It will be understood that upper surface 120 need not have a particularly large degree of curvature, or be curved at all, but in many cases such is advantageous as the same may match the anatomy of the patient or consumer, particularly is placed under the neck of back of the patient or consumer, and thus be more comfortable to the same. Support device 100a shows an embodiment of the invention with a different degree of curvature than the embodiment of support device 100.

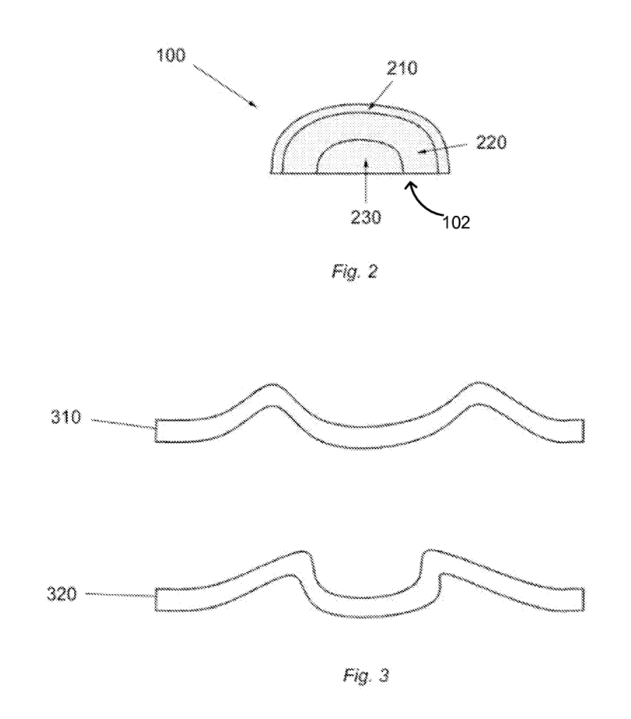

FIG. 2 illustrates one embodiment of the support device 100 that comprises three layers. Referring to FIG. 2, top layer 210 may be formed of a pressure distributive material, such as a pressure distributive gel. Top layer 210 may have a thickness of, e.g., ¼ to 1 inch. In many cases the thickness of top layer 210 will equalize upon use, in order to equally distribute pressure around all surfaces of the patient's or consumer's anatomy contacting the support device.

Middle layer 220, which in some implementations is the thickest layer, provides cushioning, like a pillow, and thus is made of soft materials such as a foam. Viscoelastic form, also known as “memory foam,” will work in some implementations.

Bottom or inner layer 230 is flexible, but also has a degree of stiffness. This layer provides the majority of the adaptability and shaping functionality, and thus is configured and structured to be formable into different shapes by user manipulation. Bottom or inner layer 230 is rigid enough to keep such shapes (as formed by the user) until such time as another shape is desired, in which case the user can either re-form the support device into the new desired shape or can extend the same into a substantially linear configuration, which may be particularly convenient for storage.

Support device 100 may also optionally include gel feet or a gel-like layer at each end. These feet provide protection for the skin when support device 100 is configured so that the ends are pressed against the user's skin. For example, support device 100 may wrap around the user's neck and then each end is bent into a position so the ends anchor on the user's upper chest.

As seen in the figure, the bottom surface 102 of the device 100 may be flat.

One of ordinary skill in the art will understand that the dimensions of support device 100 may vary. However, in certain implementations, the following dimensions have been found advantageous:

Length: 15 to 30 inches

Width: 5 to 12 inches (measuring the total curved length)

Height: 3 to 10 inches, e.g., 3 to 7 inches

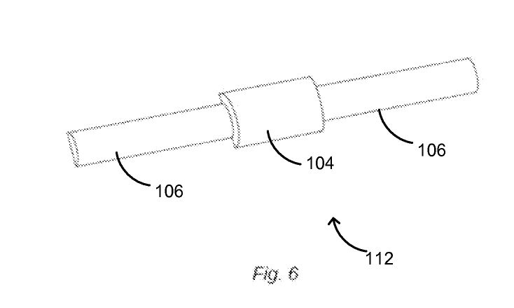

Referring to the device 112 of FIG. 6, the width and height of support device 100 may also be non-uniform. For example, the width and/or height may be greater toward the middle, e.g., portion 104, than at the ends, e.g., portions 106. The width and/or height may gradually taper from the middle to the end (not shown), or the width and/or height may decrease by steps, or a combination of tapering and steps may be used. FIG. 6 illustrates an example where the height and/or width is greater in the middle than the end, and where a step change in dimensions is used.

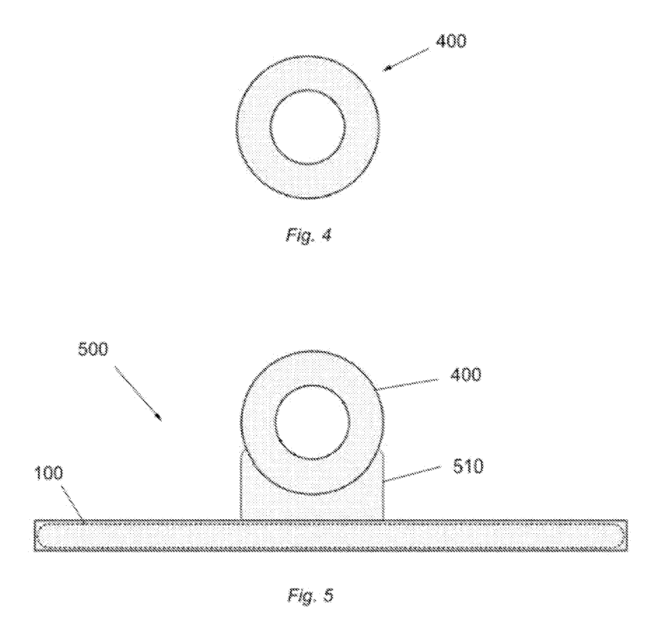

The construction of support device 100 allows the same to be formed into different shapes, according to the anatomy of the patient or consumer. Exemplary shapes are shown in FIG. 3. For example, device 310 has been shaped to support a particular patient's neck. As a further example, device 320 has been shaped to give extra support a particular patient's jaw. Generally a caregiver such as a nurse or physician will form support device 100 into a desired shape according to a patient anatomy, and the construction of support device 100 is such that support device 100 maintains the formed shape until such time as another shape is desired. The “desired shape” may include a number of shapes to conform to patient anatomy, and may also include a shape providing a neutral neck position.

In addition, the structure of support device 100 allows the same to be formed in a configuration to be placed adjacent a patient's neck to disallow significant rolling of the head from side to side, and may further be formed to support the jaw. Support device 100 may be formed to support the skull of the patient, such that the weight of the skull is not resting entirely on the spine of the patient. In the disclosed devices, the weight of the skull is transferred from the spine to the top surface of the support device 100, through the support device 100 to the bottom flat surface of support device 100, and onto the bed of the patient (or other such surface). One of ordinary skill in the art will understand other variations of shapes in which a linear version of support device 100 may be manipulated.

Variations of the systems and methods will be understood by one of ordinary skill in the art. As one example, support device 100 may be provided in multiple sizes, such as small, medium, and large. The materials used may be capable of being cleaned, hypoallergenic, supportive, adjustable and/or moldable, and may accommodate different positions and shapes during rest or sleep. The systems and methods may be advantageously applied during surgery, such as neurosurgery, in which patient head placement is critical. In many cases, systems according to present principles may be considered to provide preventative medicine, avoiding pressure sores or the like, which are expensive to treat and often are treated at a significant financial loss to hospitals.

Besides other types of patients noted herein, patients may be advantageously treated who score low on the “Braden” scale, such scores generally indicating a greater risk for the patient to develop a pressure ulcer.

FIG. 4 shows another embodiment of the present invention, for occipital use. In this case, rather than being substantially linear in shape in an unshaped configuration, the device is circular or semicircular, similar to a doughnut. FIG. 4 shows circular support device 400, although it will be understood that other embodiments may only encompass a portion of the circle.

FIG. 5 illustrates another embodiment of the present invention. FIG. 5 show combined support device 500, comprising an occipital embodiment, such as circular support device 400, detachably connected to a linear embodiment, such as support device 100, by connector 510, such as a hook and loop fastener, so as to provide both neck support and occipital support. One example of a hook and loop fastener is Velcro®. Such may be particularly important in the operating room during long surgeries including brain surgeries. Such may also be important following brain surgery, especially where a portion of the skull has been removed, in order to stop the patient's head from rolling onto a side in which removal has occurred.

In yet another embodiment, a consumer version may be provided, for use, e.g., by frequent travelers or those who sleep in chairs (for medical reasons or otherwise) or have other needs requiring head or jaw support, e.g., those with neck and jaw problems. Systems and methods disclosed herein may be employed in other non-medical areas, such as to provide a cradle for the C-spine in day spas during facials or other procedures which would benefit by having the neck be supported.

In any version, the device may be conveniently inserted into an enclosure, such as a disposable and/or breathable material or a pillowcase, to provide a relatively protective covering for the support device.

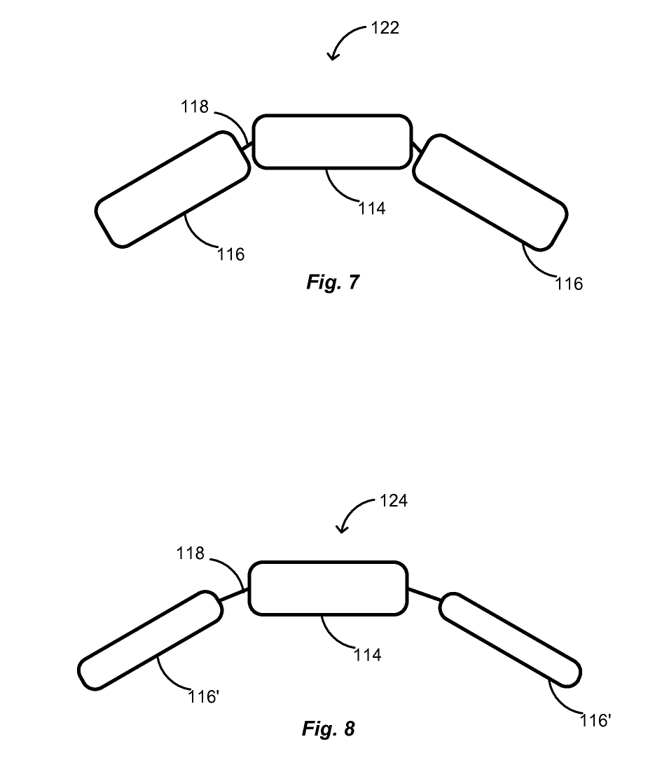

Another exemplary support device is illustrated by the device 122 of FIG. 7. In this figure, a central component 114 is illustrated having two sides 116 that are connected to the central lobe by connector 118. This has the benefit of having particularly maneuverable side lobes, so as to be configurable to a wide range of patient anatomies.

FIG. 8 illustrates another alternative implementation, this of a device 124, in which the side lobes 116′ are sized differently from the central component 114. While the elements are shown in a top view, it will be understood that the height of the components differs as well, in that the same may be equipped with a flat bottom as noted above, to allow placement on a bed surface without rolling.

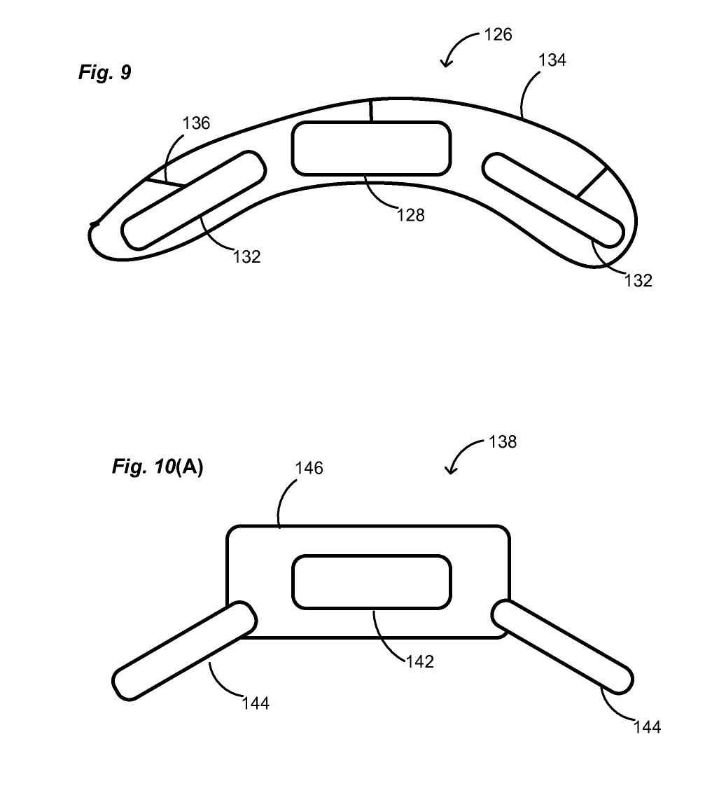

In yet another implementation, as illustrated by the device 126 of FIG. 9, the components including central core component 128, and side components 132, may be placed within a tubular structure such as a bag 134, the same providing a convenient way to keep the components together and to deploy and control the device. The components may be coupled to the bag by stitching 136 or the like.

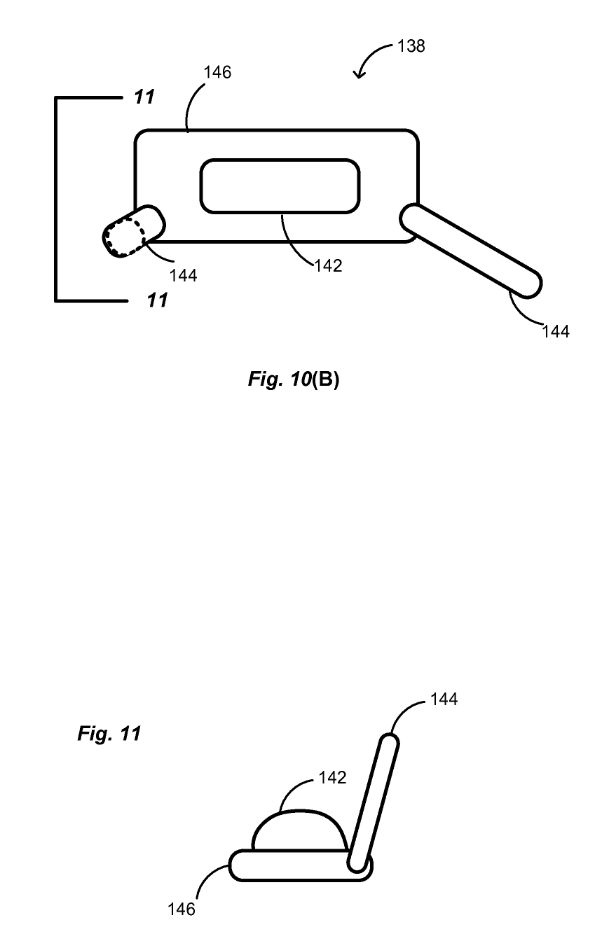

In yet another implementation, as illustrated by the device 138 of FIGS. 10(A) and 10(B) and 11, a central core component 142 is placed on a base 146. While the central core 142 generally has a flat bottom, the base 146 more of a planar sheet of material, with varying degrees of flexibility, from rigid to somewhat flexible. Side components 144 are also illustrated, in the same may be coupled to the base four to the central core component.

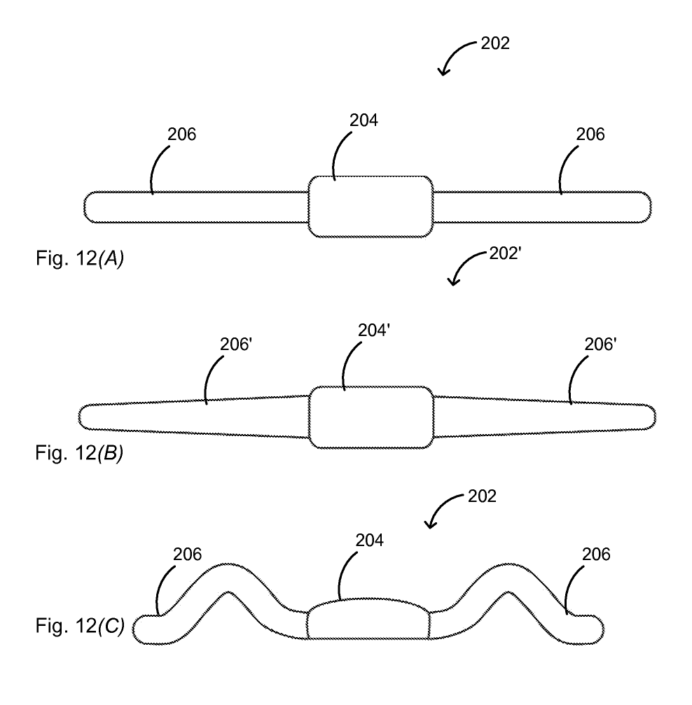

FIG. 12(A)-12(C) illustrate other alternative embodiments according to present principles. In particular, FIG. 12(A) illustrates a top view of a device 202 in which a central core component 204 is coupled to two arms 206, the two arms non-tapering. FIG. 12(B) illustrates a top view of a device 202′ in which a central core component 204′ is coupled to two arms 206′, the two arms tapering. FIG. 12(C) illustrates a side view of the device according to present principles, where the arms are formed or posed into a configuration which may be appropriate to hold a patient's head in a stable manner.

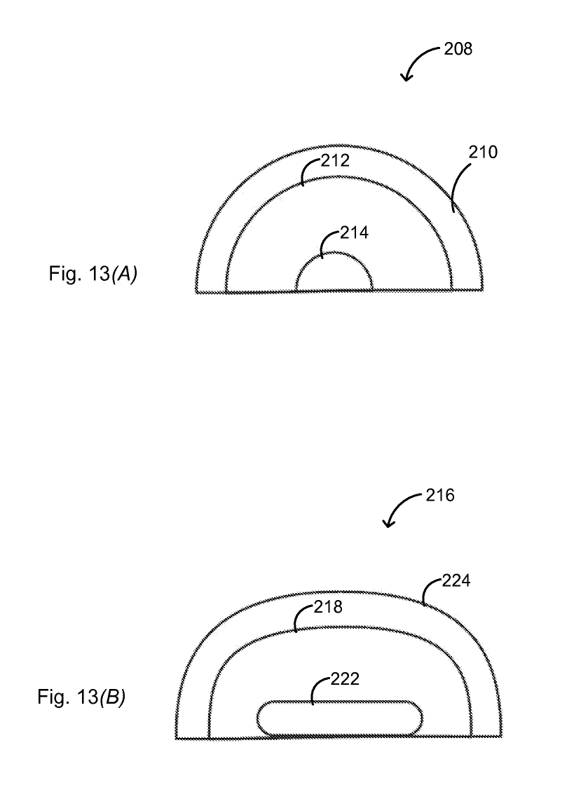

FIG. 13(A)-13(B) illustrate alternative embodiments according to present principles. In particular, FIG. 13(A) illustrates an exemplary cross-section 208 of a flexible lobe or arm, while FIG. 13(B) illustrates an exemplary cross-section 216 of a flat neck base.

The cross-section 208 may include layer 210, e.g., which may be a gel layer. A layer 212 may be beneath layer 210, and the same may constitute a foam layer. A layer 214 may be below layer 212, and the same may constitute a flexible core layer.

The cross-section 216 may include layer 224, which may also be a gel layer. The layer 218 may be below layer 224, and the same may constitute a foam layer. A layer 222 may be below layer 218, or layer 218 may surround layer 222, and layer 222 may constitute a flat base, which may be rigid or flexible.

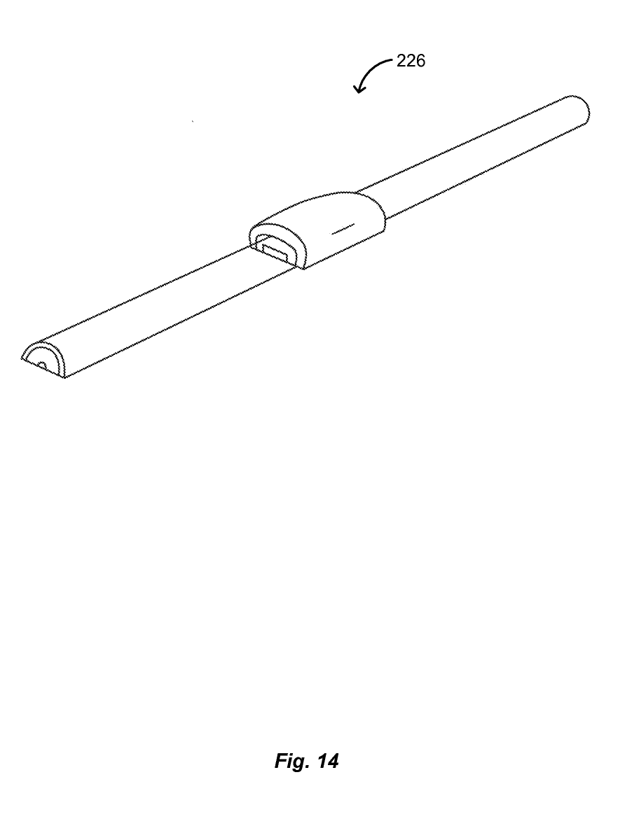

FIG. 14 illustrates a perspective view of a device 226 in which the layers of the device are shown as constituted by FIGS. 13(A) and 13(B).

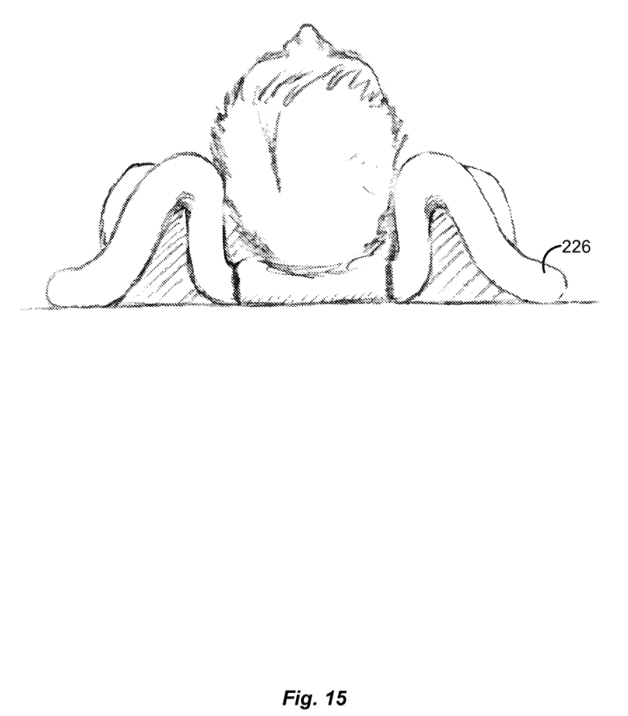

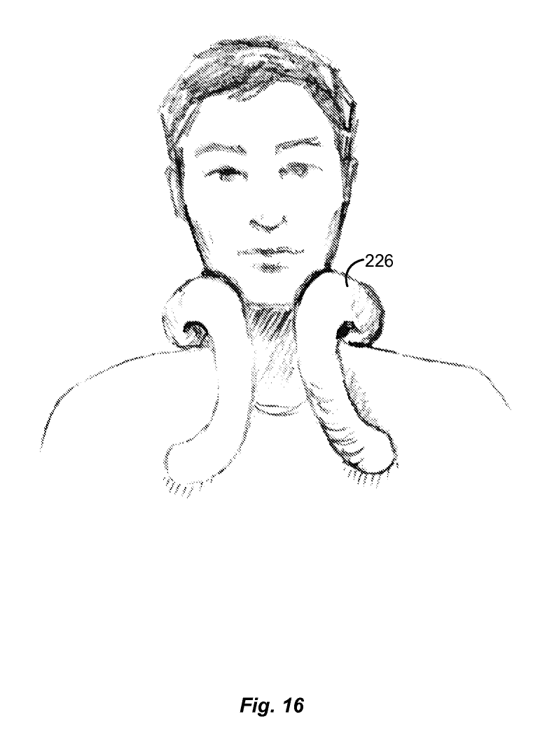

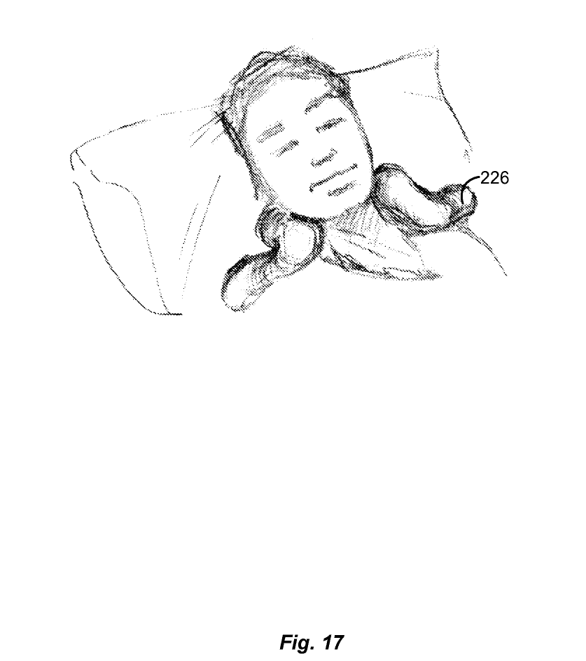

FIGS. 15-17 schematically illustrates an implementation of a device 226 according to present principles in use with patients. The figures show how the device need not lay in a single plane, but in particular the arms may wrap around the neck and head of the patient to stabilize the same, i.e., coming out of the plane of the bed and in some cases the arms may be turned back upon themselves to create a “C” shape to allow a better and more comfortable force against the neck and head of a patient. FIG. 16 illustrates a configuration for a patient who is sitting upright, showing in particular support of the jaw. FIG. 15 illustrates a configuration for a patient who is laying flat. FIG. 17 illustrates a configuration for a patient who is laying at an angle.

It is noted that while the side lobes may be a different size from the central core component, the same may include the same number of layers. Alternatively, the side lobes may be constituted of one or more materials such that there are a different number of layers in the side lobes that in the central core component. In some cases, a right side lobe will differ from a left side lobe in either the number of layers, the overall thickness, or both.

While in many of the implementations above, the side lobes or arms are arranged in position substantially in the plane of the bed, i.e., the same plane the central core component and its flat surface are situated on, the flexibility of the side lobes or arms is such that the same can be angled upward, out of the plane of the bed (see FIGS. 10(B) and 11), so as to provide support to a patient at a level higher than the thickness of the core component or side arm. For example, if a patient is desired to stay on their side, the device may be positioned with a lobe or side arm against the patient's back. The combination of the flexible side arm and the flat bottom central core component allows the system to securely perform its functions without rolling or toppling over. The combination of these aspects along with the tapering or “step down” of the arm diameter allows a convenient product, as the lessened weight of the tapered lobe makes the device less likely to topple over, and further increases the ability of the device to be flexible and to wrap around a patient's head and allow support of the jaw.

The flexibility and pose ability of the arms or side lobes may be such that the same may be configured out of the plane of the bed and still maintain its position. In some implementations, the central core component is less flexible than the side lobe components by a range of 10% to 90%, e.g., 25% to 75%, e.g., 40% to 60%, e.g., 50%. Of course, if the central core component is mounted to a base, then the same will generally be as flexible as the base, which may be rigid or may itself be flexible.

While the invention has been described with respect to certain embodiments, it should be clear to one of ordinary skill in the art, given the teachings and disclosures made herein, that the invention is much broader than the embodiments shown. For example, while brain and other neurosurgeries have been disclosed as an environment for the systems and methods according to present principles, the same may be advantageously employed in many other types of surgeries, including open heart and transplant operations. The invention may further be implemented for use in car seats for children traveling in cars, or likewise for infants. In such situations the device may be attached to the car seat or freestanding. Accordingly, the description represents some, but not all, representations, and therefore the scope of this invention is to be limited only by the claims appended to this description.

1. An apparatus for supporting anatomy, comprising:
a tubular portion including:
an upper layer made of a pressure distributive material;
a middle layer made of a soft material; and
a lower layer formable by user manipulation;
a base on which the tubular portion is mounted, the base having a flat bottom surface.

2. The apparatus of claim 1, wherein the top layer comprises a pressure distributive gel.

3. The apparatus of claim 1, wherein the top layer has a thickness of ¼ to 1 inch.

4. The apparatus of claim 1, wherein the middle layer is thicker than the top and bottom layers.

5. The apparatus of claim 1, wherein the middle layer comprises a viscoelastic foam.

6. The apparatus of claim 1, wherein the bottom layer is rigid enough to keep user-formed shapes until the shape is reformed.

7. The apparatus of claim 1, shaped to support the anatomy of a head.

8. The apparatus of claim 1, shaped to support the anatomy of a neck.

9. The apparatus of claim 1, further comprising: an end layer at each end, made of a gel-like substance.

10. The apparatus of claim 1, wherein the center portion of the apparatus is wider or taller than the ends.

11. The apparatus of claim 1, wherein the tubular portion comprises a central core component and two side lobes.

12. The apparatus of claim 11, wherein the two side lobes each have a lesser cross-sectional area than the central core component.

13. The apparatus of claim 12, wherein the side lobes taper to the lesser cross-sectional area.

14. The apparatus of claim 12, wherein the side lobes step down to the lesser cross-sectional area from the central core component.

15. A toroidal apparatus for supporting anatomy, comprising:
an upper layer made of a pressure distributive material;
a middle layer made of a soft material; and
a lower layer formable by user manipulation.

16. The apparatus of claim 15, detachably connected to the apparatus of claim 1 by a connecting device.

17. The apparatus of claim 16, wherein the connecting device is a hook and loop fastener.

18. A substantially linear apparatus for supporting anatomy, comprising:
a tubular element including:
a central core component;
a right side lobe or arm; and
a left side lobe or arm;
wherein a bottom surface of the tubular portion is substantially flat, the right and left side lobes or arms have a smaller diameter than the central core component, and where the right and left side lobes or arms are configured to have greater flexibility than the central core component.

19. The apparatus of claim 18, further comprising a base on which the tubular element is mounted.

20. The apparatus of claim 19, wherein the right and left side lobes or arms are connected to the central core component by also being mounted to the base.

21. The apparatus of claim 18, wherein the right and left side lobes are configured to be poseable, such that the same may be posed in a particular orientation and subsequently substantially maintain that orientation.
